(19) United States
(12) Patent Application Publication
(10) Pub. No.: US 2025/0196593 A1
(43) Pub. Date: Jun. 19, 2025

(54) WINDOW STRUCTURE OF VEHICLE

(71) Applicant: MAZDA MOTOR CORPORATION, Hiroshima (JP)

(72) Inventors: Kohya NAKAGAWA, Aki-gun (JP); Kenichi YAMAMOTO, Aki-gun (JP); Yuji MIYOSHI, Aki-gun (JP); Motoyasu ASAKAWA, Aki-gun (JP); Hiroyuki NAGATOMO, Aki-gun (JP)

(73) Assignee: MAZDA MOTOR CORPORATION, Hiroshima (JP)

(21) Appl. No.: 18/932,359

(22) Filed: Oct. 30, 2024

(30) Foreign Application Priority Data
Dec. 15, 2023 (JP) 2023-211834

(51) Int. Cl. B60J 1/00

(52) U.S. Cl. CPC B60J 1/006; B60J 1/007

(57) ABSTRACT

A window structure comprises a window member covering an opening portion of a window frame member and piled on a peripheral edge portion of the window frame member, a vibration-reduction adhesive agent having a storage modulus of 10-17 MPa and applied to at least part of the peripheral edge portion along the peripheral edge portion so as to adhere the window member to the peripheral edge portion, and a partition portion to partition at least part of the vibration-reduction adhesive agent in a longitudinal direction which corresponds to an application direction of the vibration-reduction adhesive agent.

### BACKGROUND OF THE INVENTION

The present invention relates to a window structure of a vehicle.

Conventionally, there may occur the membrane (film) vibration of a windshield of the vehicle which is caused by the vehicle traveling's vibrations transmitted to the windshield from a vehicle lower part. This membrane (film) vibration of the windshield possibly generates improper noises or vibrations which may cause deterioration of the comfortability of a passenger in a cabin. Therefore, in recent years, various technologies have been proposed in order to reduce the membrane (film) vibration of the windshield from an improvement perspective of the comfortability.

In a structure disclosed in Japanese Patent Laid-Open Publication No. 2009-12604, two lines of adhesive portions to adhere a windshield to a frame body are applied to a lower-side part of a windshield provided at a vehicle front side such that they extend in a vehicle width direction side by side. The two-line adhesive portions so increase the rigidity of the lower-side part of the windshield compared to another part of the windshield that the windshield' membrane (film) vibration generated in a certain frequency range in the vehicle traveling can be suppressed from occurring. Thereby, the NVH performance (regarding noises, vibrations, harshness) of the vehicle can be improved.

In the above-described structure, however, by changing a resonant frequency of the windshield in a particular frequency range of the vibrations which the windshield receives by means of the increased rigidity of the lower part of the windshield, the vibration level of the particular frequency range is decreased. Therefore, since another resonance may occur in a different frequency range when the frequency of the inputted vibration changes from the above-described particular frequency, there is a concern that the effects of reducing the vibrations may not be obtained properly.

Meanwhile, a technology that an adhesive agent to improve the vibration characteristics is replaced by a vibration-reduction adhesive agent having the superior vibration-reduction performance is known. However, there is room for improvement in this technology in terms of securing the support rigidity of the windshield by means of the vibration-reduction adhesive agent. Further, since this vibration-reduction adhesive agent is generally rather expensive compared to the normal adhesive agent for the windshield, the above-described technology has a problem in costs as well.

### SUMMARY OF THE INVENTION

The present invention has been devised in view of the above-described matters, and an object of the present invention is to provide a window structure of a vehicle which can properly improve the vibration-reduction effects, securing the support rigidity of a window member (windshield) by means of the vibration-reduction adhesive agent.

The window structure of the vehicle of the present invention comprises a window frame member having an opening portion penetrating in a vehicle longitudinal direction and a peripheral edge portion enclosing the opening portion and provided at a front part of the vehicle, a window member covering the opening portion and piled on the peripheral edge portion of the window frame member, the window member being transparent or translucent, a vibration-reduction adhesive agent having a storage modulus of 10-17 MPa and applied to at least part of the peripheral edge portion of the window frame member along the peripheral edge portion so as to adhere the window member to the peripheral edge portion of the window frame member, and a partition portion to partition at least part of the vibration-reduction adhesive agent in a longitudinal direction which corresponds to an application direction of the vibration-reduction adhesive agent.

In the above-described structure, there is the partition portion to partition at least part of the vibration-reduction adhesive agent having the storage modulus of 10-17 MPa in the longitudinal direction. Since it comes into a layer of the vibration-reduction adhesive agent by partitioning the vibration-reduction adhesive agent, the partition portion serves as a deformation resistance to suppress deformation of the vibration-reduction adhesive agent (in other words, as a reinforcing member to reinforce the vibration-reduction adhesive agent), so that the support rigidity of the window member (windshield) by means of the vibration-reduction adhesive agent can be secured. Additionally, by means of the partition portion partitioning the vibration-reduction adhesive agent, the recovery rate of the rigidity of the vibration-reduction adhesive agent for the application direction of the vibration-reduction adhesive agent, i.e., the longitudinal direction, can be improved, that is-a sharing ratio of the strain energy of the vibration-reduction adhesive agent can be improved. Accordingly, the vibration-reduction effects can be improved without increasing an application amount of the vibration-reduction adhesive agent.

In the above-described window structure of the vehicle, it is preferable that the partition portion extends in a direction which crosses the above-described longitudinal direction.

According to this structure, the vibration-reduction effects for the vibrations which are inputted to the vibration-reduction adhesive agent in the longitudinal direction or the torsional direction can be improved.

In the above-described window structure of the vehicle, it is preferable that the partition portion extends toward a center of the window member.

According to this structure, the vibration-reduction effects can be improved with a simple structure.

In the above-described window structure of the vehicle, it is preferable that the partition portion is constituted by plural portions which are positioned adjacently and extend in different directions from each other.

According to this structure, the rigidity of the adhesive agent for any direction of the shearing can be improved, so that the vibration-reduction effects can be improved.

In the above-described window structure of the vehicle, it is preferable that the plural partition portions extend in an inverted-V shape.

According to this structure, the rigidity of the adhesive agent for any direction of the shearing can be improved, so that the vibration-reduction effects can be improved.

In the above-described window structure of the vehicle, it is preferable that the vibration-reduction adhesive agent is applied to a pair of lower corner portions of the peripheral edge portion and/or a portion of the peripheral edge portion which interconnects the pair of lower corner portions, and the partition portion is provided in an area where the vibration-reduction adhesive agent is applied.

According to this structure, the vibration-reduction adhesive agent is applied to a portion of the peripheral edge portion of the window frame member which contributes to reducing the vibrations transmitted from the vehicle lower part, i.e., at the pair of lower corner portions of the peripheral edge portion and/or the portion of the peripheral edge portion which interconnects the pair of lower corner portions. Further, the partition portion is provided in the area where the vibration-reduction adhesive agent is applied. According to the above-described arrangement of the vibration-reduction adhesive agent and the partition portion, the vibration-reduction effects can be improved effectively.

In the above-described window structure of the vehicle, the partition portion may have a bead which is provided at the window frame member and extends in a short direction perpendicular to the longitudinal direction.

According to this structure, since the bead provided at the window frame member as the partition portion extends in the short direction perpendicular to the longitudinal direction, the bead does not hinder the deformation of the window frame member when the vehicle collides with a pedestrian, especially in a vehicle side collision. Thereby, since the deformation of the window frame portion is allowed even if the partition portion is provided at the window frame member, the vibration-reduction effects can be obtained without hindering the pedestrian protection.

In the above-described window structure of the vehicle, it is preferable that the partition portion further has a sub bead which is connected to the bead and extends in the longitudinal direction.

According to this structure, the rigidity of the adhesive agent for any direction of the shearing can be further improved.

In the above-described window structure of the vehicle, the partition portion may have a rib which is provided at the window member and extends in a short direction perpendicular to the longitudinal direction.

According to this structure, since the rib provided at the window member as the partition portion extends in the short direction perpendicular to the longitudinal direction, the vibration-reduction effects for the vibrations which are inputted to the vibration-reduction adhesive agent in the longitudinal direction or the torsional direction can be improved. Moreover, since the partition portion is provided at the window member, an existing window frame member with no rib is appliable.

In the above-described window structure of the vehicle, it is preferable that the partition portion further has a sub rib which is connected to the rib and extends in the longitudinal direction.

According to this structure, the rigidity of the adhesive agent for any direction of the shearing can be further improved.

As described above, the window structure of the vehicle of the present invention can properly improve the vibration-reduction effects, securing the support rigidity of the window member (windshield) by means of the vibration-reduction adhesive agent.

The present invention will become apparent from the following description which refers to the accompanying drawings.

### BRIEF DESCRIPTION OF THE DRAWINGS

FIG. 1 is an elevational view showing a window frame member and its surrounding area, which shows an entire structure of a window structure of a vehicle according to a first embodiment of the present invention.

FIG. 2 is an enlarged view of a first portion including a corner portion positioned at a lower left side of a peripheral edge portion of FIG. 1 and its surrounding area.

FIG. 3 is a perspective explanatory diagram schematically showing a state where beads as a partition portion provided at a cowl portion of the window frame member of FIG. 1 partition a vibration-reduction adhesive agent.

FIG. 4 is a perspective explanatory diagram showing plural inverted-V shaped beads which extend in an inverted-V shape with a standard at a center, in a vehicle width direction, of the cowl portion shown in FIG. 1.

FIG. 5 is a sectional explanatory view showing the state where the beads provided at the cowl portion of the window frame member of FIG. 1 partitions the vibration-reduction adhesive agent.

FIG. 6 is a graph showing a recover rate of rigidity by the bead in respective cases where the vibration-reduction adhesive agent is pulled in X, Y, XY (oblique), and Z (vertical) directions in a structure in which the bead extends in a short direction, i.e., in the X direction, which is perpendicular to the Y direction, and partitions the vibration-reduction adhesive agent, wherein an application direction of the vibration-reduction adhesive agent, i.e., a longitudinal direction, is defined as the Y direction.

FIG. 7 is a perspective explanatory diagram showing plural parallel beads which are configured to extend in parallel as a modified example of the first embodiment.

FIG. 8 is a graph showing a vibration-reduction amount caused by the vibration-reduction effects of the vibration-reduction adhesive agent when vibrations of 100-160 Hz are applied to a front windshield in respective cases of an original with no bead, the parallel beads shown in FIG. 7, and the inverted-V shaped beads shown in FIG. 4.

FIG. 9 is a perspective explanatory diagram showing the cowl portion provided with a partition portion having both a main bead extending in the short direction as the modified example of the first embodiment and a sub bead extending in the longitudinal direction.

FIG. 10 is a graph showing a relationship between a storage modulus of the adhesive agent and a strain-energy sharing ratio of the adhesive agent in respective cases of the original with no bead, the parallel beads shown in FIG. 7, and the main bead plus sub bead shown in FIG. 9.

FIG. 11 is a three-dimensional map showing a displacement amount (vibration mode) caused by the membrane (film) vibration of a front windshield of FIG. 1 and a top ceiling.

FIG. 12 is a graph showing a changing amount of sound for a base (standard) in respective cases where the adhesive agent applied to the respective portions of the peripheral edge portion of FIG. 1 is constituted by the one having the high vibration-reduction performance and constituted by the one having the high rigidity performance.

FIG. 13 is a graph showing a changing amount of vibration for a base (standard) in respective cases where the adhesive agent applied to the respective portions of the peripheral edge portion of FIG. 1 is constituted by the one having the high vibration-reduction performance and constituted by the one having the high rigidity performance.

FIG. 14 is a chart showing test results of the vibration reduction for the base (standard) in the respective cases where the adhesive agent applied to the respective portions of the peripheral edge portion of FIG. 1 is constituted by the one having the high vibration-reduction performance and constituted by the one having the high rigidity performance.

FIG. 15 is an exploded perspective explanatory diagram showing a partition portion according to a second embodiment of the present invention, in which plural ribs are provided at a lower portion of a cabin-side face of the front windshield.

FIG. 16 is a sectional explanatory diagram showing a state where the plural ribs of FIG. 15 partition the vibration-reduction adhesive agent.

### DETAILED DESCRIPTION OF THE INVENTION

### First Embodiment

Hereafter, a window structure of a vehicle according to a first embodiment of the present invention will be described specifically referring to the drawings.

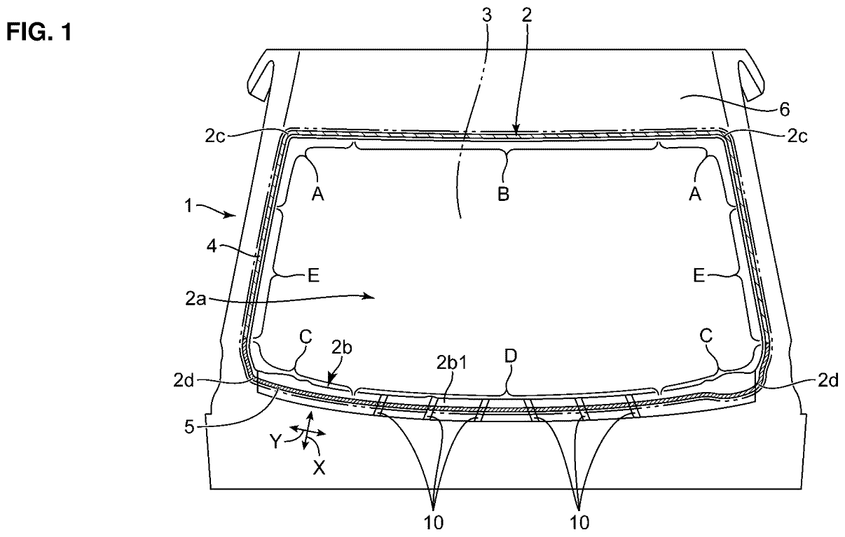

As shown in FIG. 1, a vehicle body 1 to which the window structure of the vehicle according to the first embodiment of the present invention is applied comprises a window frame member 2 provided at a front part of the vehicle, a front windshield 3 (hereafter, referred to as the windshield 3) as a window member attached to the window frame member 2, two kinds of adhesive agents to adhere the windshield 3 to the window frame member 2, i.e., a normal adhesive agent 4 for an automobile glass and a vibration-reduction adhesive agent 5, and plural beads 10 as a partition portion to partition the vibration-reduction adhesive agent 5. Herein, reference character 6 denotes a top ceiling as a top plate which extends vehicle rearward continuously from the window frame member 2 and covers over an upper face of the vehicle body 1.

The window frame member 2 comprises a roughly rectangular-shaped opening portion 2a which penetrates the window frame member 2 in a vehicle longitudinal direction and a roughly rectangular-shaped peripheral edge portion 2b which is provided to enclose a periphery of the opening portion 2a. The peripheral edge portion 2b includes a cowl portion 2b1 which constitutes a lower side portion thereof.

The peripheral edge portion 2b comprises a pair of right-and-left corner portions 2d (lower corner portions 2d) which are positioned at a lower side and both sides, in a vehicle width direction, of the peripheral edge portion 2b and a pair of corner portions 2c (upper corner portions 2c) which are positioned at an upper side and the both sides, in the vehicle width direction, of the peripheral edge portion 2b, and has a roughly rectangular shape.

More specifically, the peripheral edge portion 2b comprises a pair of upper corner portions (parts) A which include the pair of upper corner portions 2c, an upper side portion (part) B which is positioned between the pair of upper corner portions (parts) A, a pair of first portions (parts) C which correspond to the pair of lower corner portions, a second portion (part) D which is positioned between the pair of first portions (parts) C as a portion corresponding to the lower side portion, and a pair of side portions (parts) E which are positioned at the both sides, in the vehicle width direction, thereof.

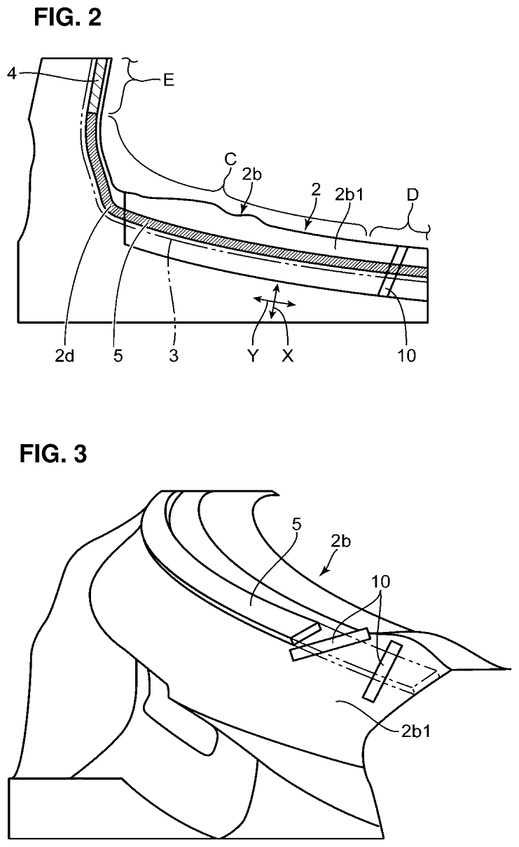

As shown in FIG. 2, each of the pair of first portions C (lower corner portions) specifically includes the corner portion 2d and a portion continuous from the corner portion 2d, and also specifically includes the corner portion 2d and a portion extending upward from the corner portion 2d and a portion extending toward a central side, in the vehicle width direction, thereof. Further, in a case where the corner portion 2d has curvature, it can be said that the first portion C includes a portion which extends from a bending-starting point of the corner portion 2d to a bending-ending point of the corner portion 2d. The above-described respective portions extending toward the central side, in the vehicle width direction, of the pair of first portions C and the above-described second portion D are included in the cowl portion 2b1 of the peripheral edge portion 2b.

The second portion D (lower side portion) is, as shown in FIG. 1, positioned between the pair of first portions C, and specifically between both portions which extend toward a central side, in the vehicle width direction, of the window frame member 2 from the respective first portions C.

The windshield 3 is a roughly rectangular-shaped window member which is provided to cover over the opening portion 2a and overlap the peripheral edge portion 2b, which is configured to be transparent or translucent.

The adhesive agent is applied to the periphery of the peripheral edge portion 2b, and adheres the front windshield 3 to the peripheral edge portion 2b of the window frame member 2. Specifically, the adhesive agent comprises the normal adhesive agent 4 for the automobile glass and the vibration-reduction adhesive agent 5 which has a greater loss coefficient than the normal adhesive agent 4. The vibration-reduction adhesive agent 5 is a so-called high vibration-reduction adhesive agent, which is a viscoelasticity having a storage modulus of 10-17 MPa. Herein, this value of the storage modulus is the one at 20° C., 100 Hz.

The vibration-reduction adhesive agent 5 has the loss coefficient which is 1.5 times or more as much as that of the normal adhesive agent 4. The normal adhesive agent 4 is cheaper than the vibration-reduction adhesive agent 5 having the greater loss coefficient.

The vibration-reduction adhesive agent 5 adheres the front windshield 3 to the window frame member 2 at the pair of first portions C and/or the second portion D of the peripheral edge portion 2b.

In the present embodiment, the vibration-reduction adhesive agent 5 is applied to both the pair of first portions C and the second portion D. Herein, the vibration-reduction adhesive agent 5 may be applied only to either one of the pair of first portions C and the second portion D.

The normal adhesive agent 4 adheres the front windshield 3 to the window frame member 2 at the portion except the above-described portion where the front windshield 3 is adhered to the window frame member 2 by the vibration-reduction adhesive agent 5. In the present embodiment, the normal adhesive agent 4 is applied to the portion except the pair of first portions C (lower corner portions) and the second portion D (lower side portion), i.e., the pair of upper corner portions A, the upper side portion B, and the pair of side portions E.

In the present embodiment, the normal adhesive agent 4 and the vibration-reduction adhesive agent 5 are applied such that an end portion of an application area of the normal adhesive agent 4 and an end portion of an application area of the vibration-reduction adhesive agent 5 are continuous to each other at their end faces. Accordingly, the respective application areas of the normal adhesive agent 4 and the vibration-reduction adhesive agent 5 become continuous, thereby securing the sealing performance.

### Description of Beads 10

As shown in FIG. 1, the beads 10 as the partition portion are arranged in an area where the vibration-reduction adhesive agent 5 is applied, i.e., at the cowl portion 2b1 of the peripheral edge portion 2b of the window frame member 2. In other words, the beads 10 are provided at both the portions of the pair of first portions C which extend toward the central side, in the vehicle width direction, of the peripheral edge portion 2b and the second portion D.

The beads 10 are, as shown in FIGS. 1-5, configured to partition at least part of the vibration-reduction adhesive agent 5 in a longitudinal direction Y which is an application direction of the vibration-reduction adhesive agent 5.

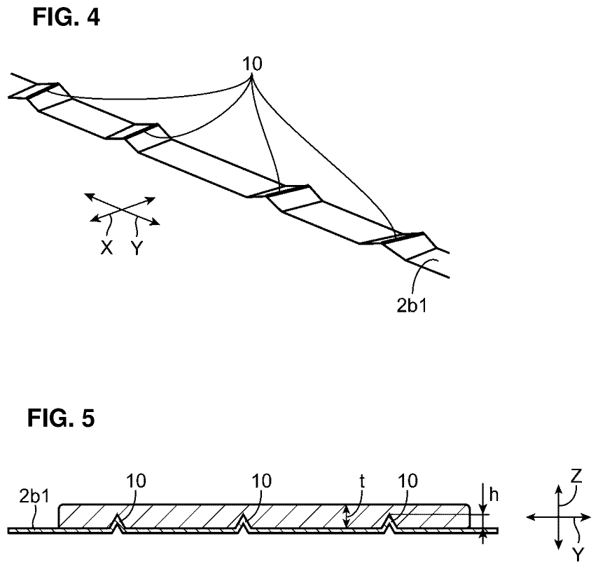

In the present embodiment, the plural beads 10 are provided to extend in an inverted-V shape in part of an area of the peripheral edge portion 2b of the window frame member 2 where the vibration-reduction adhesive agent 5 is applied, i.e., at the cowl portion 2b1 of the peripheral edge portion 2b. Specifically, as shown in FIGS. 1 and 4, the plural beads 10 extend in the inverted-V shape with a standard at a center, in the vehicle width direction, of the cowl portion 2b1. That is-the beads 10 extend in a direction away from the center, in the vehicle width direction, of the cowl portion 2b1 as they go away from a center of the windshield 3. Thus, the plural beads 10 are of the so-called inverted-V shape. Herein, a single bead 10 may be provided.

The plural inverted-V shaped beads 10 extend in the direction crossing the longitudinal direction Y, respectively. In other words, the plural beads 10 extend radially toward the center of the windshield 3. Further, it can be said that the plural beads 10 extend such that their adjacent beads 10 extend in the different directions from each other.

For example, the beads 10 may be formed by making part of the cowl portion 2b1 protrude upward as shown in FIG. 5 as long as they partition the vibration-reduction adhesive agent 5. The beads 10 may be formed on a surface of the cowl portion 2b1 by using a resin, metal, or other material.

Securing the support rigidity and improving the vibration-reduction effects can be securely attained if the height h of the bead 10 shown in FIG. 5 is 50-100% of the thickness t of the adhesive agent. For example, it can be set such that the height h of the bead 10 is about 2-4 mm in a case where the thickness t of the vibration-reduction adhesive agent 5 is 4 mm, whereas that height h is 2.5-5 mm in a case of the thickness t of 5 mm.

### Description of Rigidity Recovery Rate by Bead

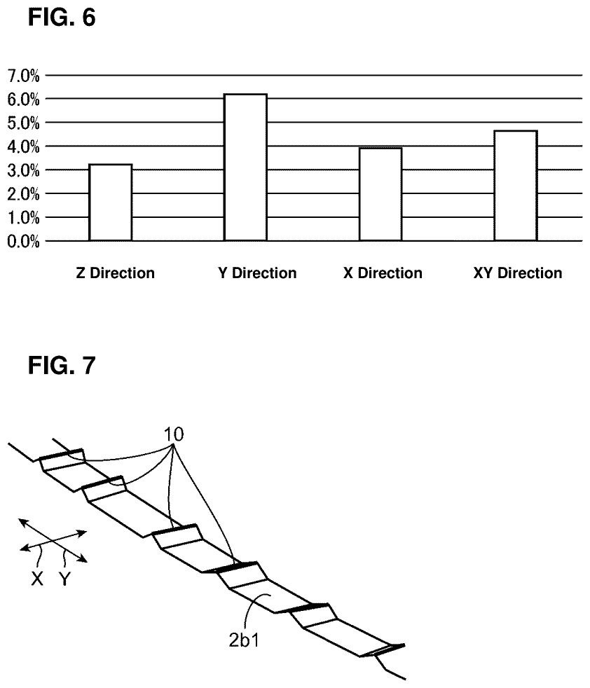

Next, the recovery rate of the rigidity of the vibration-reduction adhesive agent 5 by the beads 10 will be described referring to FIG. 6.

FIG. 6 is a graph showing the recovery rate of rigidity by the beads 10 in respective cases where the vibration-reduction adhesive agent 5 is pulled in the X, Y, XY (oblique direction which is 45-degree inclined relative to the X and Y directions), and Z (vertical) directions in a structure in which the beads 10 extend in a short direction, i.e., in the X direction, which is perpendicular to the Y direction, and partition the vibration-reduction adhesive agent 5 (specifically, the parallel-bead structure shown in FIG. 7), wherein the application direction of the vibration-reduction adhesive agent 5, i.e., the longitudinal direction, is defined as the Y direction.

It is apparent that the rigidity recovery rate of the vibration-reduction adhesive agent 5 for a tension applied in the Y direction is the largest (about 6.0%), and subsequently the one for the tension applied in the XY direction is large (about 4.5%). It is apparent from the fact that the rigidity recovery rate of the XY direction is larger than that of the X direction that a torsional rigidity of the vibration-reduction adhesive agent 5 improves.

Further, the improvement of the rigidity recovery rate of 3-4% can be attained even in respective cases where the tension is applied in the X direction, i.e., the tension is applied in the same direction as the beads 10 extending in the X direction and the tension is applied in the Z direction, i.e., the tension is applied in a thickness direction of the vibration-reduction adhesive agent 5.

Accordingly, it can be recognized that the rigidity recovery rate improves for all-direction tensioning by partitioning the vibration-reduction adhesive agent 5 by means of the beads 10. Moreover, it is apparent that a sharing ratio of the strain energy of the vibration-reduction adhesive agent 5 improves as well according to the improvement of the rigidity recovery rate. Herein, the sharing ratio of the strain energy of the vibration-reduction adhesive agent 5 means a ratio of the strain energy that the adhesive-agent shares relative to a gross of the strain energy caused by the rigidities relating to the adhesive agent and its surrounding area, i.e., three of the adhesive-agent rigidity, the adhesive-agent application-portion rigidity, and the windshield-surroundings rigidity.

### Relationship Between Bead Arrangenment and Vibration-Reduction Amount

From results of the graph of FIG. 6, while it is apparent that the sharing ratio of the strain energy of the vibration-reduction adhesive agent 5 improves as well according to the improvement of the rigidity recovery rate by providing the beads 10, it is considered that a vibration-reduction amount caused by the vibration-reduction effects which is substantially equal to an increase amount of the sharing ratio of the strain energy increases as well.

This vibration-reduction amount is considered to change according to arrangement of the beads 10. As a modified example of the bead arrangement different from the above-described inverted-V shaped arrangement of the beads 10 shown FIG. 4, a parallel bead arrangement, that is-the plural beads 10 extend in parallel in the short direction X perpendicular to the longitudinal direction Y, may be considered.

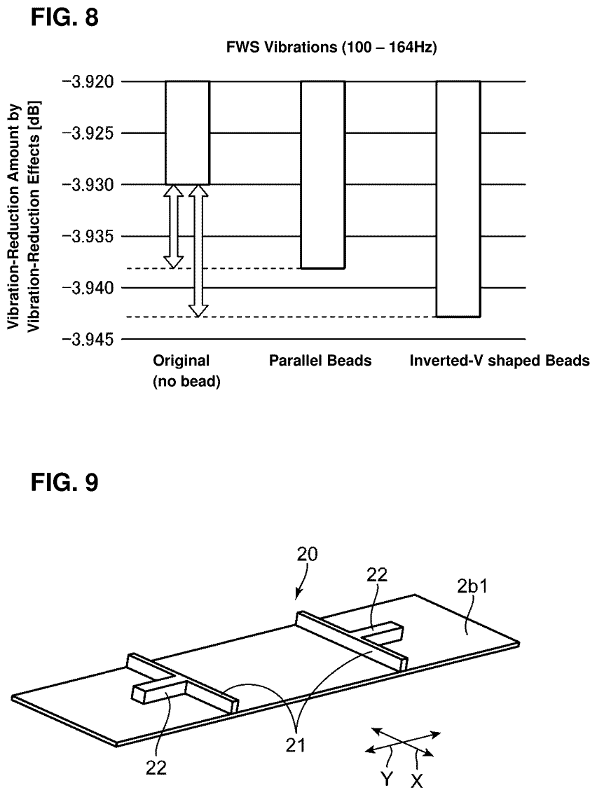

Then, as shown in the graph of FIG. 8, the vibration-reduction amount caused by the vibration-reduction effects of the vibration-reduction adhesive agent when vibrations of 100-160 Hz were applied to a front windshield in the respective cases of an original with no bead, the parallel beads shown in FIG. 7, and the inverted-V shaped beads shown in FIG. 4 was examined.

It is apparent from the graph of FIG. 8 that compared to the vibration-reduction amount (−3.93 dB) caused by the vibration-reduction effects in the case of the original, the vibration-reduction amount (−3.938 dB) in the case of the parallel beads increases by −0.008 dB, and the vibration-reduction amount (−3.943 dB) in the case of the inverted-V shaped beads increases by −0.013 dB. Accordingly, it is recognized that the inverted-V shaped beads generate the largest vibration-reduction amount. This is presumably because the inverted-V shaped beads reduce not only the vibration applied in the application direction (longitudinal direction Y) of the vibration-reduction adhesive agent 5 but the vibration applied in a direction of torsion to twist the cowl portion 2b1.

### Relationship Between Bead Arrangement and Strain-Energy Sharing Ratio of Adhesive Agent

It is considered that the sharing ratio of the strain energy of the vibration-reduction adhesive agent 5 is greatly changed by the bead arrangement. As a modified example of the bead arrangement different from the above-described parallel arrangement of the beads 10 shown FIG. 7, a combined arrangement of a main bead and a sub bead shown in FIG. 9, that is—a partition portion 20 which has main beads 21 extending in the short direction and sub beads 22 connected to the main beads 21 and extending in the longitudinal direction Y is provided at the cowl portion 2b1, can be considered.

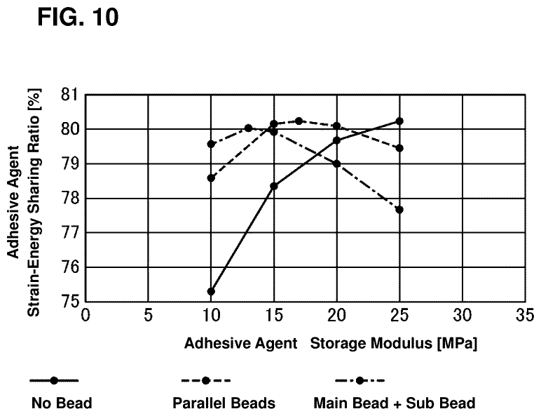

Accordingly, as shown in FIG. 10, a change of the strain-energy sharing ratio of the vibration-reduction adhesive agent 5 relative to the storage modulus of the vibration-reduction adhesive agent 5 in the respective cases of the original with no bead, the parallel beads shown in FIG. 7, and the main bead plus sub bead shown in FIG. 9 was examined.

According to the graph of FIG. 10, the strain-energy sharing ratios of the respective cases of the parallel bead and the main bead plus sub bead are higher (greater) than that of the case of original with no bead in a range of 10-17 MPa of the storage modulus of the vibration-reduction adhesive agent 5. Accordingly, it is apparent that the vibration-reduction effects of the vibration-reduction adhesive agent 5 was improved by providing the beads.

Further, since the vibration reduction can be attained securely by providing the beads in a range of 10-17MPa of the storage modulus of the vibration-reduction adhesive agent 5, this structure is applicable to a wide variety of vehicle models.

### Membrane (Film) Vibration

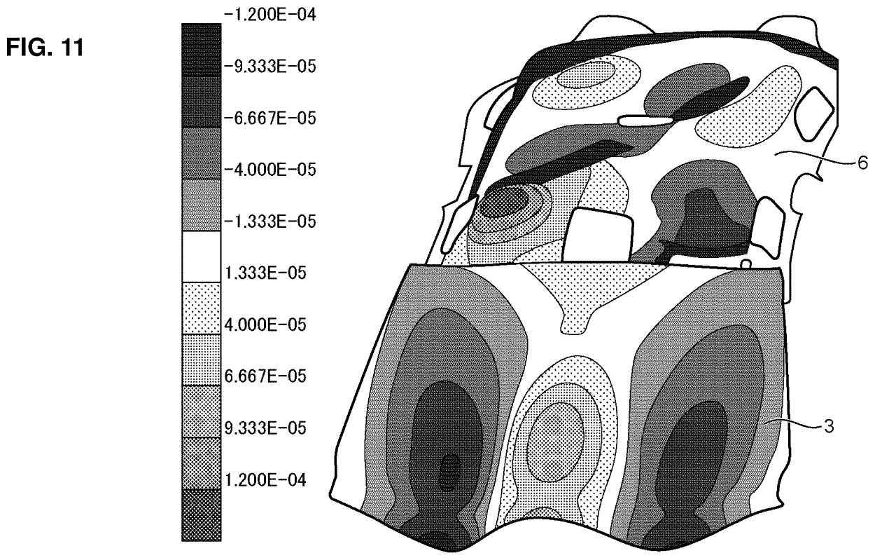

FIG. 11 shows a three-dimensional map showing a displacement amount (vibration mode) caused by the membrane (film) vibration of the front windshield 3 and the top ceiling 6 as vibration modes when the vibration of 140 Hz, one example of the vibration in the vehicle traveling, is inputted. The displacement amount is indicated by the dot-density of the upper displacement amount of 1.333E-05-1.200E-04 and the shading of the lower displacement amount of −1.333E-05-−1.200E-04.

It can be understood from the three-dimensional map of FIG. 11 that there occurs the membrane (film) vibration of the windshield 3 of the vehicle which is caused by the vehicle traveling's vibrations transmitted to the windshield 3 from the vehicle lower part and also the top ceiling 6 located above the windshield 3 has the membrane (film) vibration accordingly.

Especially, it is apparent from viewing the lower side of the windshield 3 that nodes are generated at the both-side lower corner portions and also an antinode of upward displacement is generated at the central portion of the lower side and a pair of antinodes of downward displacement are generated on both sides of the antinode of upward displacement.

Therefore, it can be recognized that by adhering at least one of the both-side lower corner portions where the nodes of the membrane (film) vibration of the windshield 3 are generated and the lower side portion where the antinode is generated, preferably the both portions, to the windshield 3 by the adhesive agent having the superior vibration-reduction effects (the so-called high vibration-reduction adhesive agent), the vibration-reduction effects are effectively improved by the fewer amount of high vibration-reduction adhesive agent.

Accordingly, since the second portion D of the lower side portion of the window frame member 2 of FIG. 1 becomes the portion where the antinode of the vibration of the windshield 3 is generated, the strain energy is accumulated at the vibration-reduction adhesive agent 5 by applying the vibration-reduction adhesive agent 5 as the high vibration-reduction adhesive agent. Further, since the pair of first portions C of the lower corner portions of the window frame member 2 of FIG. 1 become move-starting points (nodes) of the second portion D of the lower side portion, the strain energy is accumulated at the vibration-reduction adhesive agent 5 by applying the vibration-reduction adhesive agent 5 to the first portions C, so that the vibration-reduction effects are improved.

On the contrary, in a case where the high-rigidity adhesive agent is applied to the first portions C and/or the second portion D as a comparative example, it may be considered that the vibration of the second portion D increases. Further, in a case where the two-line adhesive portion is formed at the lower side portion which corresponds to the second portion D for the high rigidity, it may be considered as well that the vibration of the lower side portion (the second portion D) increases.

Next, a range for the high (superior) reduction which can effectively attain the superior reduction of the sound and vibration at the peripheral edge portion 2b of the window frame member 2 will be considered comparing to a range for the high rigidity of a comparative example.

### Consideration of Range for High Reduction

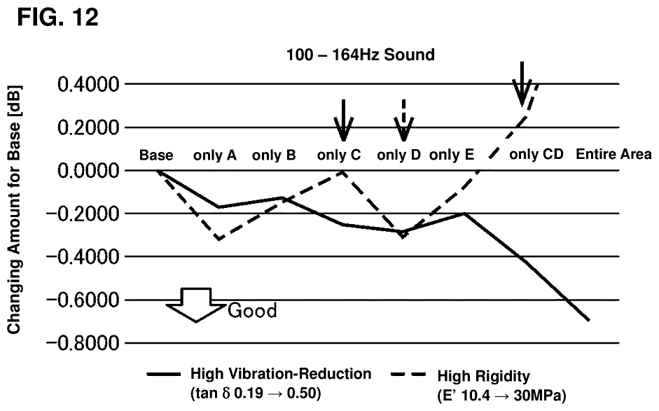

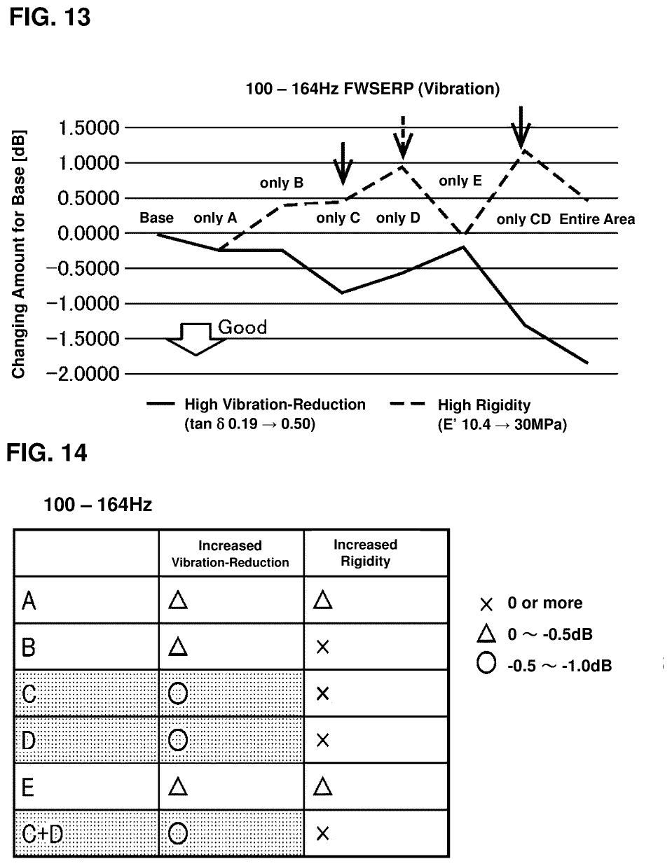

First, referring to the graphs of FIGS. 12 and 13, respective changing amounts of the sound and vibration in two cases where the adhesive agent applied to the respective portions A-E of the peripheral edge portion 2b is constituted by the one having the high vibration-reduction performance and constituted by the one having the high rigidity performance when the vibration (100-164 Hz) in the vehicle traveling is applied to the windshield 3 are examined. Herein, the vibration of the windshield 3 is examined.

FIG. 12 is a graph showing the changing amount of the sound for a base (standard) (i.e., a basic adhesive agent without the high vibration-reduction performance nor the high rigidity performance (a normal adhesive agent for the automobile glass with the loss coefficient tan δ 0.19)). FIG. 13 is a graph showing the changing amount of the vibration for the base.

As shown in FIGS. 12 and 13, in the case where the adhesive agent applied to the respective portions A-E of the peripheral edge portion 2b is constituted by the one having the high vibration-reduction performance (the loss coefficient tan δ 0.19->0.50) (see the solid line-graphs of FIGS. 12 and 13), the respective changing amounts of the sound and vibration for the base decrease for the base. Further, the above-described changing amounts decrease the most in the case where the adhesive agent applied only to the first portion C and the second portion D is constituted by the one having the high vibration-reduction performance, and its decreasing becomes near the changing amount of the comparative example where the adhesive agent applied to the respective portions A-E is constituted by the one having the high vibration-reduction performance. Further, it is apparent that the changing amounts of the sound and vibration in the case where the adhesive agent applied only to the first portion C (see FIGS. 12 and 13) is constituted by the one having the high vibration-reduction performance decrease, and the changing amounts of the sound and vibration in the case where the adhesive agent applied only to the second portion D (see FIGS. 12 and 13) is constituted by the one having the high vibration-reduction performance decrease more. Particularly, it is apparent from the graph of FIG. 13 that there occurs the decrease of 0.5 dB or more in the respective cases of the applications only to the first portion C, only to the second portion D, and only to the first and second portions C and D. As described above, the reduction effects of the sound and vibration can be securely obtained regardless of the frequency of the input vibration by using the adhesive agent having the high vibration-reduction performance.

Meanwhile, it can be understood that in the case of the comparative example where the adhesive agent applied to the respective portions A-E of the peripheral edge portion 2b is constituted by the one having the high rigidity performance (a storage modulus E′ 10.4→30 MPa) (see the broken-line graphs of FIGS. 12 and 13), the cases where the adhesive agent applied only to the first and second portions C and D (see FIGS. 12 and 13) is constituted by the one having the high rigidity performance show the largest changing amount of the sound and vibration, so that there occurs no reduction effect of the sound and vibration. Further, in the case where the adhesive agent applied only to the second portion D (see FIGS. 12 and 13) is constituted by the one having the high rigidity performance, the changing amount of the sound in FIG. 13 becomes small but the changing amount of the vibration in FIG. 5 becomes larger than the base, so that the vibration-reduction effect is not obtained. Moreover, in the case where the adhesive agent applied only to the first portion C (see FIGS. 12 and 13) is constituted by the one having the high rigidity performance, the both changing amounts of the sound and vibration in FIGS. 12 and 13 become large, so that the reduction effects of the sound and vibration are not obtained. Thus, it is apparent that the reduction effects of the sound and vibration are not obtained sufficiently by using the adhesive agent having the high rigidity performance.

As shown by a chart of FIG. 14, test results of the vibration reduction for the base can be obtained from the above-described changing amounts of the vibration shown by the graphs of FIG. 13 in the respective cases where the adhesive agent applied to the portions A-E of the peripheral edge portion 2b is constituted by the one having the high vibration-reduction performance (the increased vibration reduction in FIG. 14) and constituted by the one having the high rigidity performance (the increased rigidity in FIG. 14).

According to the chart shown in FIG. 14, it is recognized that the superior (high) vibration-reduction effects of −0.5 dB or more can be obtained by the increased vibration reduction of either one of the first portion C and the second portion D or the both. Meanwhile, it is understood that in a case where the rigidity is increased for either one of the first portion C and the second portion D or the both, the changing amount becomes 0 dB or more, so that the vibration increases improperly.

### Features of First Embodiment

(1)

The above-described window structure of the vehicle of the first embodiment comprises the vibration-reduction adhesive agent 5 having the storage modulus of 10-17 MPa as the adhesive agent to adhere the windshield 3 to the peripheral edge portion 2b of the window frame portion 2 and the plural beads 10 as the partition portion to partition at least part of the vibration-reduction adhesive agent 5 in the longitudinal direction Y. Herein, the bead 10 may be constituted by a single piece alternatively.

Since they come into a layer of the vibration-reduction adhesive agent 5 by partitioning the vibration-reduction adhesive agent 5, the beads 10 serve as a deformation resistance to suppress deformation of the vibration-reduction adhesive agent 5 (in other words, as a reinforcing member to reinforce the vibration-reduction adhesive agent 5), so that the support rigidity of the windshield 3 by means of the vibration-reduction adhesive agent 5 can be secured. Additionally, by means of the beads 10 partitioning the vibration-reduction adhesive agent 5, the recovery rate of the rigidity of the vibration-reduction adhesive agent 5 for the application direction of the vibration-reduction adhesive agent 5, i.e., the longitudinal direction Y, can be improved, that is-a sharing ratio of the strain energy of the vibration-reduction adhesive agent 5 can be improved. Accordingly, the vibration-reduction effects can be improved without increasing an application amount of the vibration-reduction adhesive agent 5.

(2)

In the window structure of the first embodiment, the beads 10 extend in the direction which crosses the longitudinal direction Y. Accordingly, the vibration-reduction effects for the vibrations which are inputted to the vibration-reduction adhesive agent 5 in the longitudinal direction Y or the torsional direction can be improved.

(3)

In the window structure of the first embodiment, the beads extend toward the center of the windshield 3 radially. According to this structure, the vibration-reduction effects can be improved with a simple structure.

(4)

In the window structure of the first embodiment, the beads 10 are configured to be positioned adjacently and extend in the different directions from each other. Accordingly, the rigidity of the adhesive agent for any direction of the shearing can be improved, so that the vibration-reduction effects can be improved.

(5)

In the window structure of the first embodiment, the beads 10 are configured to extend in the inverted-V shape. Accordingly, the rigidity of the adhesive agent for any direction of the shearing can be improved, so that the vibration-reduction effects can be improved.

Herein, while the plural inverted-V shaped beads 10 shown in FIGS. 1 and 4 extend in the direction away from the center, in the vehicle width direction, of the cowl portion 2b1 as they go away from the center of the windshield 3, the present invention is not limited to this. The plural beads 10 may be arranged side by side in the vehicle width direction such that the adjacent two beads 10 form the inverted-V shape or the V shape.

(6)

In the window structure of the first embodiment, the vibration-reduction adhesive agent 5 is applied to the pair of first portions C which include the pair of lower corner portions 2d of the peripheral edge portion 2b and/or the second portion D of the peripheral edge portion 2d which interconnects the pair of first portions C. In the present embodiment, the vibration-reduction adhesive agent 5 is applied to both the pair of first portions C and the second portion D. The beads 10 are provided in the area where the vibration-reduction adhesive agent 5 is applied, i.e., at both the second portion D and the portions of the pair of first portions C which extend toward the center, in the vehicle width direction, of the peripheral edge portion 2b.

According to this structure, the vibration-reduction adhesive agent 5 is applied to the portion of the peripheral edge portion 2b of the window frame member 2 which contributes to reducing the vibrations transmitted from the vehicle lower part, i.e., at the pair of lower corner portions of the peripheral edge portion 2b and/or the portion of the peripheral edge portion 2b which interconnects the pair of lower corner portions. Further, the beads 10 are provided in the area where the vibration-reduction adhesive agent 5 is applied. According to the above-described arrangement of the vibration-reduction adhesive agent 5 and the beads 10 as the partition portion, the vibration-reduction effects can be improved effectively.

(7)

In the window structure of the first embodiment, as shown in FIG. 7, the partition portion may have the beads 10 which are provided at the cowl member 2b1 of the peripheral edge portion 2b of the window frame member 22 and extend in the short direction X perpendicular to the longitudinal direction Y.

According to this structure, since the beads 10 provided at the window frame member 2 as the partition portion extend in the short direction X perpendicular to the longitudinal direction Y, the bead 10 do not hinder the deformation of the window frame member 2 when the vehicle collides with a pedestrian, especially in the vehicle side collision. Thereby, since the deformation of the window frame portion 2 is allowed even if the beads 10 as the partition portion are provided at the window frame member 2, the vibration-reduction effects can be obtained without hindering the pedestrian protection.

(8)

In the window structure of the first embodiment, as shown in FIG. 9, the partition portion 20 further has the sub beads 22 which are connected to the main beads 21 extending in the short direction X and extend in the longitudinal direction Y. According to this structure, the rigidity of the adhesive agent for any direction of the shearing can be further improved.

### Second Embodiment

While the beads 10 are provided at the cowl portion 2b1 which constitutes the lower side of the peripheral edge portion 2b of the window frame member 2 as the partition portion to partition the vibration-reduction adhesive agent 5 in the above-described first embodiment, the present invention is not limited to this.

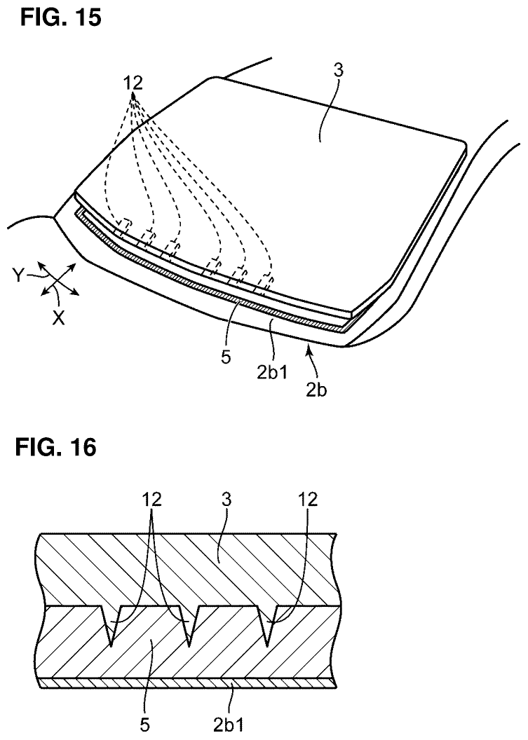

Then, in the second embodiment, as shown in FIGS. 15 and 16, the partition portion to partition the vibration-reduction adhesive agent 5 have the ribs 12 which are provided at the windshield 3 and extend in the short direction X perpendicular to the longitudinal direction Y. The ribs 12 are constituted by plural pieces which are provided to be separated from each other in the vehicle width direction neat at a lower side of a back face of the windshield 3.

According to this structure, since the ribs 12 provided at the windshield 3 as the partition portion extend in the short direction X perpendicular to the longitudinal direction Y, the vibration-reduction effects for the vibrations which are inputted to the vibration-reduction adhesive agent 5 in the longitudinal direction Y or the torsional direction can be improved. Moreover, since the partition portion is provided at the windshield 3, the existing window frame member 2 with no rib is appliable.

Further, similarly to the first embodiment, the partition portion may further have sub ribs which are connected to the main ribs 12 shown in FIG. 15 and extend in the longitudinal direction Y like the partition portion 20 having the main beads 21 and the sub beads 22 which are shown in FIG. 10. According to this structure, the rigidity of the adhesive agent for any direction of the shearing can be further improved.

What is claimed is:

1. A window structure of a vehicle, comprising:
a window frame member having an opening portion penetrating in a vehicle longitudinal direction and a peripheral edge portion enclosing the opening portion and provided at a front part of the vehicle;
a window member covering the opening portion and piled on the peripheral edge portion of the window frame member, the window member being transparent or translucent;
a vibration-reduction adhesive agent having a storage modulus of 10-17 MPa and applied to at least part of the peripheral edge portion of the window frame member along the peripheral edge portion so as to adhere the window member to the peripheral edge portion of the window frame member; and
a partition portion to partition at least part of said vibration-reduction adhesive agent in a longitudinal direction which corresponds to an application direction of said vibration-reduction adhesive agent.

2. The window structure of the vehicle of claim 1, wherein said partition portion extends in a direction which crosses said longitudinal direction.

3. The window structure of the vehicle of claim 2, wherein said partition portion extends toward a center of said window member.

4. The window structure of the vehicle of claim 3, wherein said partition portion is constituted by plural portions which are positioned adjacently and extend in different directions from each other.

5. The window structure of the vehicle of claim 4, wherein said plural partition portions extend in an inverted-V shape.

6. The window structure of the vehicle of claim 5, wherein said vibration-reduction adhesive agent is applied to a pair of lower corner portions of said peripheral edge portion and/or a portion of the peripheral edge portion which interconnects said pair of lower corner portions, and said partition portion is provided in an area where the vibration-reduction adhesive agent is applied.

7. The window structure of the vehicle of claim 1, wherein said vibration-reduction adhesive agent is applied to a pair of lower corner portions of said peripheral edge portion and/or a portion of the peripheral edge portion which interconnects said pair of lower corner portions, and said partition portion is provided in an area where the vibration-reduction adhesive agent is applied.

8. The window structure of the vehicle of claim 1, wherein said partition portion has a bead which is provided at said window frame member and extends in a short direction perpendicular to said longitudinal direction.

9. The window structure of the vehicle of claim 1, wherein said partition portion has a rib which is provided at said window member and extends in a short direction perpendicular to said longitudinal direction.

10. The window structure of the vehicle of claim 2, wherein said partition portion is constituted by plural portions which are positioned adjacently and extend in different directions from each other.

11. The window structure of the vehicle of claim 2, wherein said vibration-reduction adhesive agent is applied to a pair of lower corner portions of said peripheral edge portion and/or a portion of the peripheral edge portion which interconnects said pair of lower corner portions, and said partition portion is provided in an area where the vibration-reduction adhesive agent is applied.

12. The window structure of the vehicle of claim 2, wherein said partition portion has a bead which is provided at said window frame member and extends in a short direction perpendicular to said longitudinal direction.

13. The window structure of the vehicle of claim 2, wherein said partition portion has a rib which is provided at said window member and extends in a short direction perpendicular to said longitudinal direction.

14. The window structure of the vehicle of claim 7, wherein said partition portion has a bead which is provided at said window frame member and extends in a short direction perpendicular to said longitudinal direction.

15. The window structure of the vehicle of claim 7, wherein said partition portion has a rib which is provided at said window member and extends in a short direction perpendicular to said longitudinal direction.

16. The window structure of the vehicle of claim 8, wherein said partition portion further has a sub bead which is connected to said bead and extends in said longitudinal direction.

17. The window structure of the vehicle of claim 9, wherein said partition portion further has a sub rib which is connected to said rib and extends in said longitudinal direction.

18. The window structure of the vehicle of claim 3, wherein said vibration-reduction adhesive agent is applied to a pair of lower corner portions of said peripheral edge portion and/or a portion of the peripheral edge portion which interconnects said pair of lower corner portions, and said partition portion is provided in an area where the vibration-reduction adhesive agent is applied.
